(19) United States
(12) Patent Application Publication
(10) Pub. No.: US 2019/0383040 A1
(43) Pub. Date: Dec. 19, 2019

(54) CLAMP FOR REMOVABLY SECURING A PLANK TO AN ELONGATED MEMBER

(71) Applicant: Jacques Gilbert, St-Benjamin (CA)

(72) Inventor: Jacques Gilbert, St-Benjamin (CA)

(21) Appl. No.: 16/439,643

(22) Filed: Jun. 12, 2019

(30) Foreign Application Priority Data
Jun. 13, 2018 (GB) 1809721.2

(51) Int. Cl. E04G 7/28; F16M 13/02; F16B 2/10; F16B 9/02; E04G 1/14

(52) U.S. Cl. CPC E04G 7/28; F16M 13/022; E04G 1/14; F16B 9/02; F16B 2/10

(57) ABSTRACT

A clamp for securing a plank to an elongated member of a scaffold. The clamp includes a body and a pair of legs extending from the body longitudinally spaced apart from each. The legs each define a leg recess for receiving the elongated member, the leg recesses each defining a leg recess nadir at a location furthest away from the body. A lock is mounted to the body and defines a plank engaging tip, the lock being movable between a lock extended position and a lock retracted position. In the lock extended position, the plank engaging tip is closer to the leg recess nadirs than in the lock retracted position.

### FIELD OF THE INVENTION

The present invention relates to the general field of removable clamps and is more specifically concerned with a clamp for removably securing a plank to an elongated member, for example an elongated member part of a scaffold structure.

### BACKGROUND

Temporary scaffold structures are often used in the construction industry. For example, such scaffold structures include a frame made of elongated metal members secured to each other. Planks, for example wood planks, are then secured at suitable locations on the metal structure so that workers can stand on the planks or to serve as guardrails. To ensure the safety of the workers, it is advantageous to secure the planks so that they don't risk becoming detached from the metal structure accidentally. On the other hand, it is advantageous to be able to erect the scaffold structures quickly.

Against this background, there exists a need in the industry to provide a clamp for removably securing a plank to an elongated member. An object of the present invention is therefore to provide such a clamp.

### SUMMARY OF THE INVENTION

In a broad aspect, there is provided clamp for securing a plank to an elongated member of a scaffold, the clamp including a substantially elongated body; a pair of legs extending from the body, the legs being longitudinally spaced apart from each other relative to body, the legs each defining a leg recess, the leg recesses being in register with each other so that the elongated member is receivable simultaneously in both leg recesses with the body substantially parallel to the elongated member, the leg recesses each defining a leg recess nadir at a location furthest away from the body; a lock mounted to the body and defining a plank engaging tip, the lock being movable between a lock extended position and a lock retracted position, wherein, in the lock extended position, the plank engaging tip is closer to the leg recess nadirs than in the lock retracted position; and a pair of auxiliary hooks each defining a respective auxiliary hook recess, each auxiliary hook being mounted at a respective one of the legs so as to be movable between a closed position in which at least part of the auxiliary hook recess is in register with at least part of an adjacent one of the leg recesses and an open position in which the auxiliary hook recess is retracted from the adjacent one of the leg recesses; whereby, with the elongated member received in the leg recesses and the plank positioned between the body and the elongated member, with the lock in the lock extended position, the plank engaging tip engages the plank and biases the plank against the elongated member to lock the plank between the elongated member and the clamp as the elongated member is in turn biased towards the leg recess nadirs.

There may also be provided a clamp wherein the auxiliary hook and leg recesses open towards each other when the auxiliary hook is in the open position.

There may also be provided a clamp wherein the auxiliary hook recess defines an auxiliary hook recess nadir in register with the leg recess nadir when the auxiliary hook is in the closed position.

There may also be provided a clamp wherein each auxiliary hook is pivoted about a respective pivot when moving between the open and closed positions.

There may also be provided a clamp wherein each auxiliary hook is also translatable relative to the pivot between a hook retracted position and a hook extended position, the auxiliary hook recess nadir being closer to the pivot in the hook retracted position than in the hook extended position.

There may also be provided a clamp further comprising a pair of translational biasing elements each biasing a respective one of the auxiliary hooks towards the hook retracted positions.

There may also be provided a clamp further comprising a pair of pivotal biasing element each biasing a respective one of the auxiliary hooks towards the closed position.

There may also be provided a clamp wherein each leg defines a respective abutment against which the auxiliary hook abuts in the closed position to prevent further movement of the auxiliary hook away from the open position.

There may also be provided a clamp wherein the legs are provided at longitudinally opposed ends of the body.

There may also be provided a clamp wherein the lock includes a threaded shaft threadedly engaged in a shaft receiving aperture extending through the body, the plank engaging tip being at one end of the shaft and an actuator being at another end of the shaft and operatively coupled thereto to allow an intended user to rotate the shaft to move the plank engaging tip relative to the shaft receiving aperture.

There may also be provided a clamp wherein the legs are substantially parallel to each other.

There may also be provided a clamp wherein the body defines a plank engaging edge engaging the plank when the clamp operatively mounts the plank to the elongated member, the plank engaging edge being configured and sized for penetrating a surface of the plank.

There may also be provided a clamp wherein the plank engaging edge is serrated.

There may also be provided a clamp wherein the plank engaging edge is a rectilinear sharp edge.

There may also be provided a clamp wherein the legs and the auxiliary hook are each substantially planar and substantially parallel to each other.

There may also be provided a clamp wherein each auxiliary hook defines a handle portion protruding away from the body substantially opposed to the legs.

There may also be provided a clamp wherein the leg recesses are substantially V-shaped at the leg recess nadir.

There may also be provided a clamp wherein the leg recesses have a substantially J-shaped peripheral edge and open laterally relative to the body.

There may also be provided a clamp wherein the auxiliary hook recesses have a substantially J-shaped peripheral edge and open laterally relative to the body when in the closed position.

In another broad aspect, there is provided a scaffold, including a plurality of elongated members; a plank extending between and abutting against a clamped member and an other member both part of the plurality of elongated members, the clamped member and the other member being substantially parallel to each other; and a clamp securing the plank to the clamped member, the clamp including a substantially elongated body extending substantially parallel to the clamped member, the plank being located between the body and the clamped member; a pair of legs extending from the body, the legs being longitudinally spaced apart from each other relative to body, the legs each defining a leg recess, the clamped member being received in both leg recesses, the leg recesses each defining a leg recess nadir at a location furthest away from the body; a lock mounted to the body and defining a plank engaging tip, the lock being movable between a lock extended position and a lock retracted position, wherein, in the lock extended position, the plank engaging tip is closer to the leg recess nadirs than in the lock retracted position; and a pair of auxiliary hooks each defining a respective auxiliary hook recess, each auxiliary hook being mounted at a respective one of the legs so as to be movable between a closed position in which at least part of the auxiliary hook recess is in register with at least part of an adjacent one of the leg recesses and an open position in which the auxiliary hook recess is retracted from the adjacent one of the leg recesses; wherein, in the lock extended position, the plank engaging tip engages the plank and biases the plank against the clamped member to lock the plank between the one of the elongated members and the clamp as the clamped member is in turn biased towards the leg recess nadir, and, in the lock retracted position, the plank engaging tip is spaced apart from the plank, thereby allowing removal of the plank from between the one of the elongated members and the body.

Advantageously, the clamp can be used to relatively quickly and effectively secure the plank to the elongated member. In some embodiments, the clamp is usable with a wide variety of shapes and dimensions of elongated member. In some embodiments, the clamp can be manufactured relatively inexpensively.

The present application claims priority from UK Request for a Patent 1809721.2 filed Jun. 13, 2018, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a top perspective view, illustrates an embodiment of a clamp for removably securing a plank to an elongated member, according to the present invention, here shown securing a plank to a typical elongated member of a scaffold, a lock of the clamp being shown in a lock extended position;

FIG. 2, in a side elevational view, illustrates the clamp of FIG. 1;

FIG. 3, in a front cross-sectional view, illustrates the clamp of FIGS. 1 and 2 along section line III of FIG. 2;

FIG. 4, in a side elevational view, illustrates the clamp of FIGS. 1 to 3, here shown receiving a plank to an elongated member of circular cross-section having a relatively small diameter, the lock of the clamp being shown in a lock retracted position;

FIG. 5, in a side elevational view, illustrates an alternative clamp, here shown securing a plank to an elongated member of circular cross-section having a relatively large diameter;

FIG. 6, in a side elevational view, illustrates the clamp of FIG. 5, here shown securing a plank to an elongated member having a relatively large and square shaped cross-section;

FIG. 7, in a side elevational view, illustrates another embodiment of a clamp for removably securing a plank to an elongated member, according to the present invention, the clamp being shown with an auxiliary hook thereof in an open position and in a hook retracted position;

FIG. 8, in a side elevational view, illustrates yet another embodiment of a clamp for removably securing a plank to an elongated member, according to the present invention;

FIG. 9, in a top perspective view, illustrates yet another embodiment of a clamp for removably securing a plank to an elongated member, according to the present invention.

FIG. 10, in a side elevational view, illustrates the clamp of FIG. 7, the clamp being shown with the auxiliary hook in a closed position and in the hook retracted position;

FIG. 11, in a side elevational view, illustrates the clamp of FIG. 7, the clamp being shown with the auxiliary hook thereof in the open position and in a hook extended position; and

FIG. 12, in a perspective view, illustrates a scaffold in which two clamps of FIG. 1 is used to attach the plank to two parallel elongated members of the scaffold.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention.

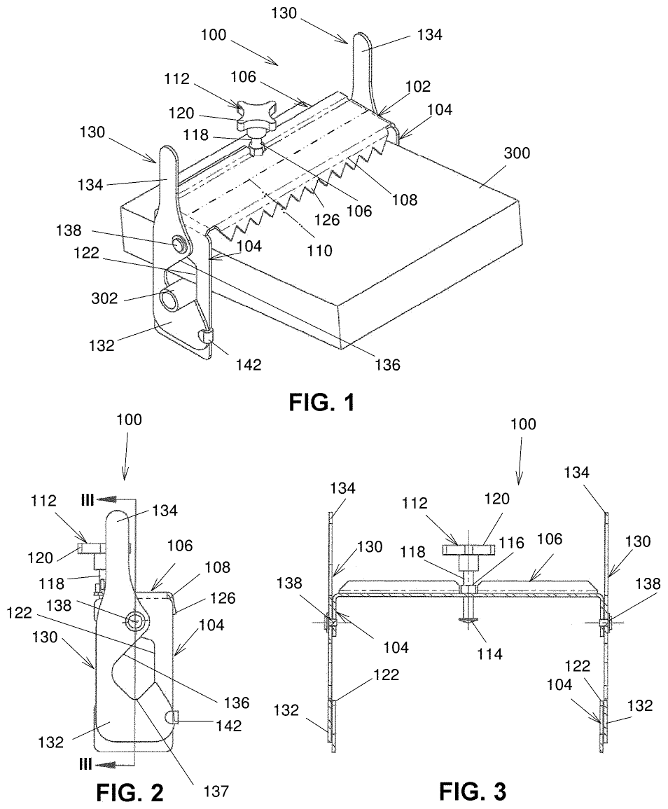

FIG. 1 illustrates a clamp 100 for removably securing at least one plank 300 abutting transversally across an elongated member 302 such as, typically, an elongated member 302, for example of tubular configuration, of a construction scaffold 304, shown in FIG. 12. The construction scaffold 304 typically includes a plurality of elongated members 302 that are pairwise parallel to each other. Such pairs are typically either horizontal or vertical. Diagonally extending elongated members 302 may also be used between the pairwise parallel ones. Planks 300 (only one of which is shown in FIG. 12) are positioned so as to extend between and abut against some of the elongated members 302 pairs. In the context of the invention, one clamp 100 is used to secure the planks 300 to each one of the elongated members 302 in each pair, but using only one clamp 100 for each plank 300 is also within the scope of the claims. The plank 300 is typically made of wood, but planks 300 made of other materials, for example of a suitable polymer, are within the scope of the invention.

Referring to FIG. 1, in one embodiment of the invention, the clamp 100 includes a substantially elongated body 106 and a pair of legs 104 extending from the body 106, the legs 104 being longitudinally spaced apart from each other relative to body 106. For example, the legs 104 are provided at longitudinally opposed ends of the body 106 and are substantially parallel to each other, so that the clamp 100 may include a U-shaped member 102 made of a single piece of material defining the body 106 and the legs 104. However, this is not required in all embodiments of the invention. In some embodiments, the clamp 100 is suitably sized and configured for securing one, two or more planks 300 parallelly stacked together.

The body 106 typically defines a plank engaging edge 108 extending parallelly longitudinally in a spaced apart relationship relative to a central longitudinal axis 110 of the body 106, and in some embodiments protruding substantially laterally relative to the legs 104. The U-shaped member 102 is configured for freely engaging in a saddle-like fashion at least one plank 300 from an opposite side thereof relative to the elongated member 302, and with both legs 104 being sufficiently sized and configured for removably engaging transversally a respective portion of the elongated member 302.

Referring for example to FIG. 5, the legs 104 each define a leg recess 122. The leg recesses 122 are in register with each other so that the elongated member 302 is receivable simultaneously in both leg recesses 122 with the body 106 substantially parallel to the elongated member 302. The leg recesses 302 are typically non-convex, or concave, and each define a leg recess nadir 125 at a location furthest away from the body 106. In other words, the leg recesses 122 have a portion thereof, the leg recess nadir 125, that is furthest away from the body 106 at which adjacent portions of the leg recess 122 on both sides of the leg recess nadir 125 are closer to the body 106, so that an elongated member 302 received in the leg recesses 122 adjacent the leg recess nadir 125 and biased towards the leg recess nadir 125, or away from the body 106, is secured in the leg recess 122.

In some embodiments, the legs 104 are generally J-shaped and define an opening 127 opening laterally between the body 106 and the leg recess nadir 125, allowing insertion of the elongated member 302 laterally, parallel to the body 106, in the leg recess 122. In some embodiments of the invention, the leg recesses 122 of each leg 104 extend laterally inwardly relative to a same lateral side relative to the body 106. However, in other embodiments, the leg recesses 122 extend laterally inwardly relative to opposed lateral sides relative to the body 106 (not shown in the figures).

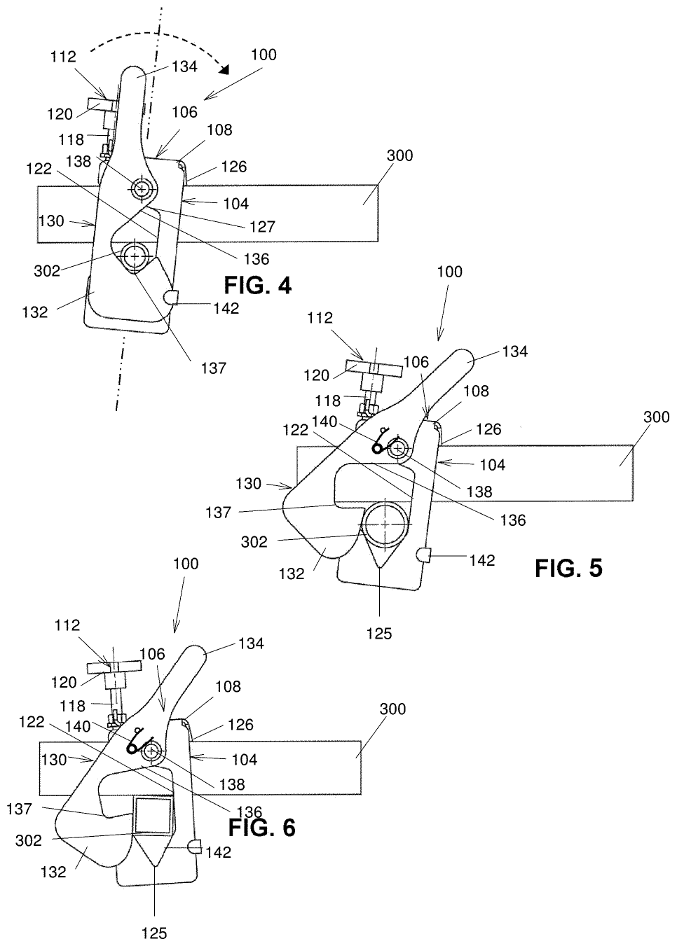

Typically, the clamp 100 further comprises at least one lock 112 mounted to the body 106 and defining a plank engaging tip 114, seen for example in FIG. 3. The lock 112 is movable between a lock extended position (seen for example in FIGS. 1 and 3) and a lock retracted position (seen for example in FIG. 4). In the lock extended position, the plank engaging tip 114 is closer to the leg recess nadirs 125 than in the lock retracted position. In some embodiments, the lock 112 is mounted to the body 106 and located substantially diametrically opposite the plank engaging edge 108 relative to the central longitudinal axis 110 of the body 106.

Referring to FIG. 3, the lock 112 includes a plank engaging tip 114 that moved when the lock is moved between the lock retracted position, in which the plank engaging tip 114 is adjacent the body 106, and the lock extended position, in which the plank engaging tip 114 is spaced apart from the body 106 and located between the legs 104.

Accordingly, as best illustrated in FIG. 4, with the U-shaped member 102 engaged on the at least one plank 300 and the elongated member 302, and the plank engaging tip 114 in the retracted position, when the plank engaging tip 114 is selectively moved to the extended position, the latter is pushed against the at least one plank 300. Thus the U-shaped member 102 is pivoted about the elongated member 302 so as to forcibly engage the plank engaging edge 108 into the adjacent surface of the at least one plank 300. Hence, the at least one plank 300 is removably secured to the elongated member 302. Thus, with the elongated member 302 received in the leg recesses 122 and the plank 300 positioned between the body 106 and the elongated member 302, with the lock 112 in the lock extended position, the plank engaging tip 114 engages the plank 300 and biases the plank 300 against the elongated member 302 to lock the plank 300 between the elongated member 302 and the clamp 100 as the elongated member 302 is in turn biased towards the leg recess nadirs 125.

Typically, the elongated member 302 is a horizontal or a vertical tubular scaffold support member having a typical diameter generally found in the field. In some embodiments, the U-shaped member 102 is made out of a single plate of a substantially rigid metal using a suitable punch-press process.

In some embodiments of the invention, the lock 112 is substantially longitudinally centered relative to the body 106. In some embodiments of the invention, the clamp 100 includes two or more locks 112 distributed in a longitudinally spaced apart relationship relative to the body 106.

Referring again to FIG. 3, in some embodiments of the invention, each lock 112 includes a threaded shaft 118 threadedly engaged in a shaft receiving aperture 116 extending through the body 106. The plank engaging tip 114 is at one end of the shaft 118 and an actuator 120 is at another end of the shaft 118 and operatively coupled thereto to allow an intended user to rotate the shaft 118 to move the plank engaging tip 114 relative to the shaft receiving aperture 116. Typically, the shaft receiving aperture 116 is oriented substantially parallelly relative to the legs 104. The actuator 112 may take for example the form of a hand knob, but other actuators 120 are within the scope of the invention.

In some embodiments of the invention, as illustrated for example, in FIGS. 2 and 3, the leg recesses 122 are substantially V-shaped at the leg recess nadir 125, but rounded, square or other similar shapes at the leg recess nadir 125 are within the scope of the invention.

Referring to FIGS. 1, 4 and 9, in some embodiments of the invention, the plank engaging edge 108 further extends at least partially angularly toward the at least one plank 300, as illustrated by the distally and angularly extending lip 126. The plank engaging edge 108 is in some embodiments configured and sized for penetrating a surface of the plank For example, as illustrated in FIG. 1, the plank engaging edge 108 may be toothed, or serrated. In other examples, as illustrated in FIG. 9, the plank engaging edge may be rectilinear, for example sharp enough for firmly engaging a relatively soft plank surface.

Referring to FIG. 3, in some embodiments of the invention, the clamp 100 further comprises a pair of auxiliary hooks 130 each defining a respective auxiliary hook recess 136, seen in FIG. 2 for example. Each auxiliary hook 130 is mounted at a respective one of the legs 104 so as to be movable between a closed position, seen for example in FIG. 4, in which at least part of the auxiliary hook recess 136 is in register with at least part of an adjacent one of the leg recesses 122, and an open position, seen for example in FIG. 5, in which the auxiliary hook recess 136 is retracted from the adjacent one of the leg recesses 122. For example, each one in the pair of auxiliary hooks 130 has a substantially elongate configuration and includes a hook member 132 at one end and a handle 134 at an opposite end thereof. Typically, the auxiliary hook and leg recesses 136 and 122 open towards each other when the auxiliary hook 130 is in the open position. In some embodiments, the auxiliary hook recess 136 defines an auxiliary hook recess nadir 137 in register with the leg recess nadir 125 when the auxiliary hook 130 is in the closed position. For example, each auxiliary hook 130 is made out of a single plate of a substantially rigid metal using a suitable punch-press process.

In some embodiments, each auxiliary hook 130 is pivoted about a respective pivot 138 when moving between the open and closed positions. For example, each one in the pair of auxiliary hooks 130 is pivotally connected along an outer lateral portion of a respective one of the legs, for example adjacent the body 106, and pivotable about a common pivot axis extending parallelly relative to the central longitudinal axis 110. The pivot 138 is for example a pivot pin mounted to the U-shaped member 102 at an intermediate location between the handle 134 and the hook member 132. In some embodiments, the legs 104 and the auxiliary hooks 130 are each substantially planar and substantially parallel to each other.

Thus, as illustrated in FIG. 4, with the plank engaging tip 114 in the retracted position, each hook member 132 is sufficiently sized and configured to freely pivot and engage the elongated member 302 having a relatively smaller diameter than the leg recess 122. For relatively large elongated members 302, as comparatively illustrated in FIGS. 5 and 6, the auxiliary hook 130 may remain in the open position when the plank 300 is secured with the clamp 100.

Referring to FIGS. 5 and 6, in some embodiments of the invention, each one in the pair of auxiliary hooks 130 is spring-biased relative to the U-shaped member 102 towards the closed position. Thus a spring biased safety barrier is provided for preventing the elongated member 302 from accidentally exiting the leg recess 122. For example, each one in the pair of auxiliary hooks 130 may be biased via a loop spring element 140 suitably connected between the latter and the respective leg 104.

In some embodiments, the clamp 100 further includes a stop member 142 located along a side edge of each leg 104 that is opposite relative to the hook opening 127 thereof, for stopping the pivoting movement of the respective auxiliary hook 130 beyond the closed position, away from the open position.

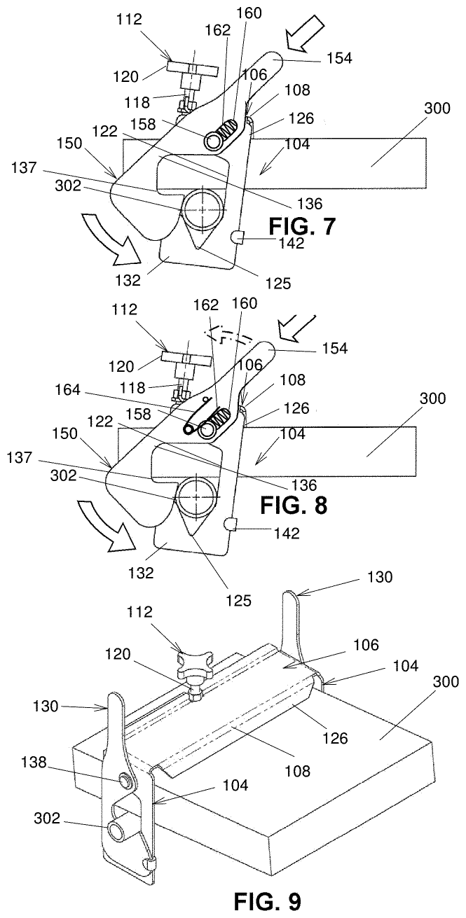

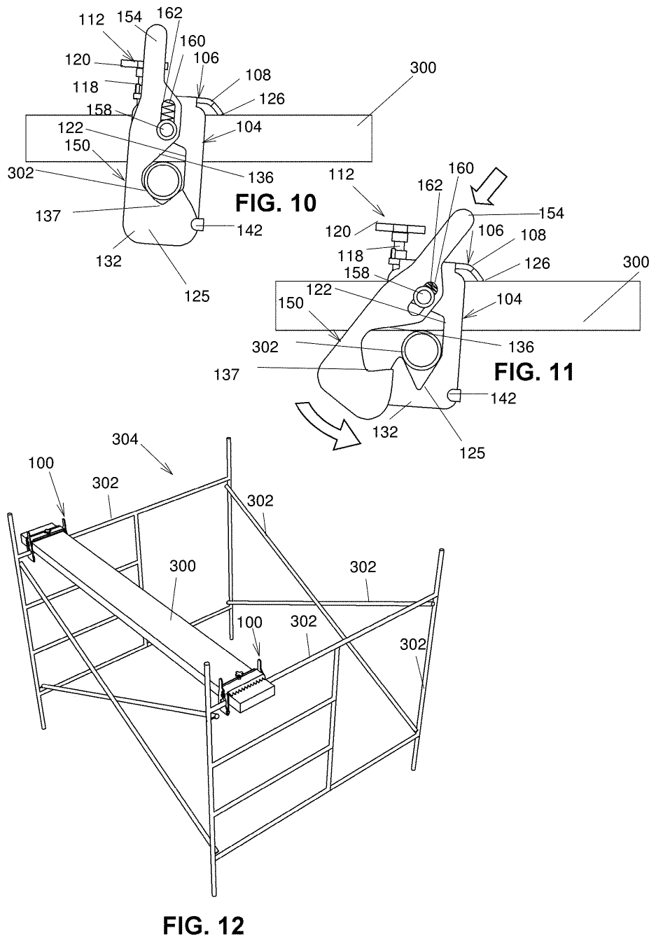

Referring to FIGS. 7, 8, 10 and 11, in some embodiments of the invention, each auxiliary hook 150 is also translatable relative to the pivot 158 between a hook retracted position, seen in FIGS. 7, 8 and 10, and a hook extended position, seen in FIG. 11. The auxiliary hook recess nadir 137 is closer to the pivot 138 in the hook retracted position than in the hook extended position. In some embodiments, as seen in the drawings, the movement between the hook extended and retracted positions is independent of the movement between the open and closed positions. In other embodiments, such movements could be coupled, for example by using a suitable cam surface engaging a guiding pin or a similar structure.

The auxiliary hooks 150 are similar to the auxiliary hooks 130 and as such have a substantially elongated configuration and includes a hook member 152 at one end and a handle 154 extending opposite thereto. Furthermore, each one in the pair of auxiliary hooks 150 is pivotally connected along an outer lateral portion of a respective one in the pair legs 104 and adjacent the body 106, and further about a common pivot axis extending parallelly relative to the central longitudinal axis 110. However, each auxiliary hook 150 is also slidably engaged on the pivot 158 through a pin slot 160 receiving the pivot 158. The pin slot 160 extends longitudinally along the auxiliary hook 150 and through the thickness of the auxiliary hook 150, at an intermediate location between the handle 154 and the hook member 152. Typically, the auxiliary hooks 150 are also biased towards the hook retracted positions, for example through a coil spring element 162 or an equivalent biasing element suitably connected between the respective leg 104 or pivot 158 and the auxiliary hook 150.

Thus, once the plank engaging tip 114 is in the extended position, each auxiliary hook 150 may be pivotally and slidably moved so as to have their hook member 152 removably engaged about the elongated member 302 in a spring-biased fashion. Hence, a safety means is provided for preventing the clamp 100 from inadvertently falling off a scaffold 304 when the plank engaging tip 114 is moved to the retracted position.

Referring more particularly to FIG. 8, in some embodiments of the invention, each auxiliary hook 150 is further spring-biased relative to the U-shaped member 102, similarly to the auxiliary hooks 130 using a loop spring element 164 for example, such that its auxiliary hook recess 156 is pivoted toward the leg recess 122 of the respective leg 104, thus providing a spring biased safety barrier preventing the elongated member 302 from accidentally exiting the leg recesses 122 when the pair of auxiliary hooks 150 are not yet engaged on the elongated member 302.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A clamp for securing a plank to an elongated member of a scaffold, the clamp comprising
a substantially elongated body;
a pair of legs extending from the body, the legs being longitudinally spaced apart from each other relative to body, the legs each defining a leg recess, the leg recesses being in register with each other so that the elongated member is receivable simultaneously in both leg recesses with the body substantially parallel to the elongated member, the leg recesses each defining a leg recess nadir at a location furthest away from the body;
a lock mounted to the body and defining a plank engaging tip, the lock being movable between a lock extended position and a lock retracted position, wherein, in the lock extended position, the plank engaging tip is closer to the leg recess nadirs than in the lock retracted position; and
a pair of auxiliary hooks each defining a respective auxiliary hook recess, each auxiliary hook being mounted at a respective one of the legs so as to be movable between a closed position in which at least part of the auxiliary hook recess is in register with at least part of an adjacent one of the leg recesses and an open position in which the auxiliary hook recess is retracted from the adjacent one of the leg recesses;
whereby, with the elongated member received in the leg recesses and the plank positioned between the body and the elongated member, with the lock in the lock extended position, the plank engaging tip engages the plank and biases the plank against the elongated member to lock the plank between the elongated member and the clamp as the elongated member is in turn biased towards the leg recess nadirs.

2. The clamp as defined in claim 1, wherein the auxiliary hook and leg recesses open towards each other when the auxiliary hook is in the open position.

3. The clamp as defined in claim 2, wherein the auxiliary hook recess defines an auxiliary hook recess nadir in register with the leg recess nadir when the auxiliary hook is in the closed position.

4. The clamp as defined in claim 3, wherein each auxiliary hook is pivoted about a respective pivot when moving between the open and closed positions.

5. The clamp as defined in claim 4, wherein each auxiliary hook is also translatable relative to the pivot between a hook retracted position and a hook extended position, the auxiliary hook recess nadir being closer to the pivot in the hook retracted position than in the hook extended position.

6. The clamp as defined in claim 5, further comprising a pair of translational biasing elements each biasing a respective one of the auxiliary hooks towards the hook retracted positions.

7. The clamp as defined in claim 4, further comprising a pair of pivotal biasing element each biasing a respective one of the auxiliary hooks towards the closed position.

8. The clamp as defined in claim 4, wherein each leg defines a respective abutment against which the auxiliary hook abuts in the closed position to prevent further movement of the auxiliary hook away from the open position.

9. The clamp as defined in claim 1, wherein the legs are provided at longitudinally opposed ends of the body.

10. The clamp as defined in claim 1, wherein the lock includes a threaded shaft threadedly engaged in a shaft receiving aperture extending through the body, the plank engaging tip being at one end of the shaft and an actuator being at another end of the shaft and operatively coupled thereto to allow an intended user to rotate the shaft to move the plank engaging tip relative to the shaft receiving aperture.

11. The clamp as defined in claim 1, wherein the legs are substantially parallel to each other.

12. The clamp as defined in claim 1, wherein the body defines a plank engaging edge engaging the plank when the clamp operatively mounts the plank to the elongated member, the plank engaging edge being configured and sized for penetrating a surface of the plank.

13. The clamp as defined in claim 12, wherein the plank engaging edge is serrated.

14. The clamp as defined in claim 13, wherein the plank engaging edge is a rectilinear sharp edge.

15. The clamp as defined in claim 1, wherein the legs and the auxiliary hook are each substantially planar and substantially parallel to each other.

16. The clamp as defined in claim 15, wherein each auxiliary hook defines a handle portion protruding away from the body substantially opposed to the legs.

17. The clamp as defined in claim 1, wherein the leg recesses are substantially V-shaped at the leg recess nadir.

18. The clamp as defined in claim 1, wherein the leg recesses have a substantially J-shaped peripheral edge and open laterally relative to the body.

19. The clamp as defined in claim 1, wherein the auxiliary hook recesses have a substantially J-shaped peripheral edge and open laterally relative to the body when in the closed position.

20. A scaffold, comprising
a plurality of elongated members;
a plank extending between and abutting against a clamped member and an other member both part of the plurality of elongated members, the clamped member and the other member being substantially parallel to each other; and
a clamp securing the plank to the clamped member, the clamp including;
a substantially elongated body extending substantially parallel to the clamped member, the plank being located between the body and the clamped member;
a pair of legs extending from the body, the legs being longitudinally spaced apart from each other relative to body, the legs each defining a leg recess, the clamped member being received in both leg recesses, the leg recesses each defining a leg recess nadir at a location furthest away from the body;
a lock mounted to the body and defining a plank engaging tip, the lock being movable between a lock extended position and a lock retracted position, wherein, in the lock extended position, the plank engaging tip is closer to the leg recess nadirs than in the lock retracted position; and
a pair of auxiliary hooks each defining a respective auxiliary hook recess, each auxiliary hook being mounted at a respective one of the legs so as to be movable between a closed position in which at least part of the auxiliary hook recess is in register with at least part of an adjacent one of the leg recesses and an open position in which the auxiliary hook recess is retracted from the adjacent one of the leg recesses;
wherein, in the lock extended position, the plank engaging tip engages the plank and biases the plank against the clamped member to lock the plank between the one of the elongated members and the clamp as the clamped member is in turn biased towards the leg recess nadir, and, in the lock retracted position, the plank engaging tip is spaced apart from the plank, thereby allowing removal of the plank from between the clamped member and the body.
